(19) United States
(12) Patent Application Publication
(10) Pub. No.: US 2011/0001887 A1
(43) Pub. Date: Jan. 6, 2011

(54) Zero standby power RF controlled device

(76) Inventors: Peter Rae Shintani, San Diego, CA (US); Robert Blanchard, Escondido, CA (US); Brant L. Candelore, San Diego, CA (US)

Correspondence Address: MILLER PATENT SERVICES, 2500 DOCKERY LANE, RALEIGH, NC, 27606, US

(21) Appl. No.: 12/459,569

(22) Filed: Jul. 2, 2009

(51) Int. Cl. H04N 5/44; H04B 1/06

(52) U.S. Cl. 348/734; 455/352; 348/E05.096

(57) ABSTRACT

A remotely controllable electronic appliance has a radio frequency energy converter that receives a radio frequency energy from a remote controller and converts the radio frequency energy to electrical energy, where the electrical energy from the energy converter is used to supply power to receive a turn-on code. This abstract is not to be considered limiting, since other embodiments may deviate from the features described in this abstract.

### CROSS REFERENCE TO RELATED DOCUMENTS

This application is related to “Zero Standby Power Laser Controlled Device” to Candelore, et. al. filed of even date herewith bearing docket number SY-02280.01 U.S. patent application Ser. No. ______, which is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Current remote controlled electronic appliances such as home entertainment devices (e.g., television sets, video disc players and the like) consume a small amount of power when turned “off”. This is because the standard “off” mode for a television (TV) set or the like is more akin to a “standby” mode. This has been found necessary in order to prepare the appliance to be fully powered up by use of a remote controller. Accordingly, the appliance utilizes a small amount of standby power to energize a remote control code receiver. In this manner, when the user presses an “on” or “on/off” button on the remote controller, the appliance's remote control code receiver circuitry is powered up and ready to fully power up the appliance (e.g., the TV set).

Unfortunately, although such remote control code receiver circuitry is very low in power consumption (often in the range of about 100 mWatt), when multiplied by multiple devices within a household and millions of households, the aggregate energy consumption is quite substantial and contributes to the detriment of the environment.

While one can reduce this energy consumption to zero by fully switching off power to the appliance or unplugging the appliance, it seems that few people are actually willing to do so, and doing so eliminates the possibility of remote control power-up.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example of a block diagram of a system consistent with certain embodiments of the present invention.

FIG. 2 is an example of a more detailed block diagram of a system consistent with certain embodiments of the present invention.

FIG. 3 is an example flow chart of a process carried out in the controlled appliance consistent with certain embodiments of the present invention.

FIG. 4 is an example flow chart of a process carried out in a remote controller consistent with certain embodiments of the present invention.

FIG. 5 is flow chart of a process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

By way of example, a television set is used herein as the target appliance, but this should not be considered limiting since any remote controlled device could equally well be the target appliance.

In accord with certain embodiments, the power supply is allowed to totally turn off, thus turning off all circuitry in the device, and providing a mechanism through the remote control to turn on the power supply. This is accomplished by use of radio frequency (RF) energy to supply the power that determines if it is appropriate to turn the power supply on. No energy is stored power in the appliance (e.g., TV) to power a standby circuit. The appliance is truly “off”.

In one physical layer implementation RF energy is used in a manner similar to its use in an RF ID tag. The remote control emits an RF signal, which is received by a resonant circuit in the target appliance. The system is designed such that the RF power received by the appliance's resonant circuit would allow it to turn the appliance's power supply on. At this point the appliance is able to receive infrared IR commands from the remote control. If the remote control is bi-directional, the appliance could also signal the remote to turn off the RF wake up signal.

If the RF powered switch only needed to turn on the standby power supply of the display, the power required is even lower. Using the current state of the art of RF ID tags a range of several meters is easily achieved.

In certain implementations, RF energy is used to power a switch that turns on a remote control code interpreter. Generating sufficient RF power is straightforward and inexpensive. Similarly, the resonant circuit and available power is well known from the RF ID technology.

In addition, the RF receiver in the device can be opportunistic, in that is can use unintentional RF energy to charge itself but be idle until it received the correctly encoded signal to turn on.

Furthermore, the system can be partitioned so the impact to the TV design could be limited to that of the standby power supply. The standby supply could be placed in stasis, and be in a static non-power consuming state until the RF link activates it, and then the powering up sequence could be the same as that of a typical TV.

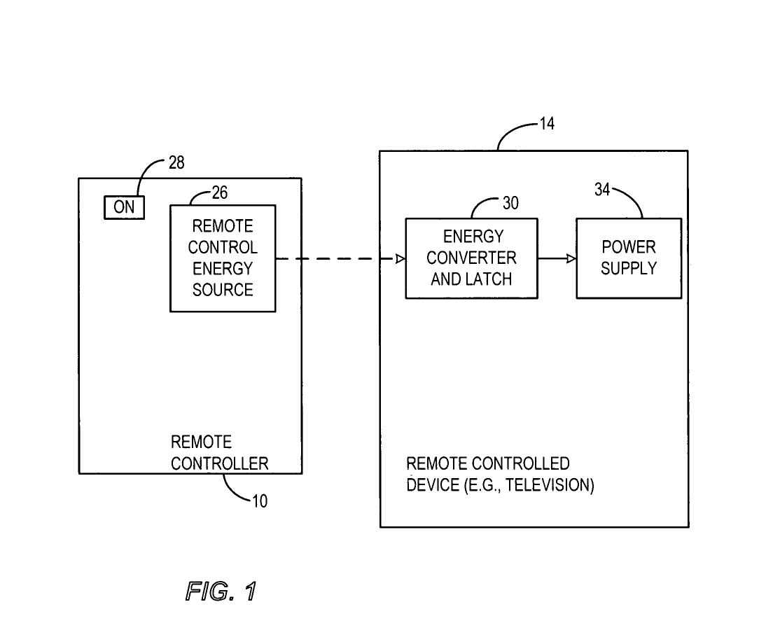

Turning now to FIG. 1, an example embodiment consistent with the invention is depicted in block diagram form. In this example, a remote controller 10 communicates with a television set or other controlled device 14. In certain implementations, multiple coding methods can be used to communicate. In this example, radio frequencies (RF) is used. In accord with certain embodiments, a remote control energy source 26 comprises an RF energy source that is used to stimulate an energy conversion device (such as a resonant circuit and an RF to DC converter) that closes a latch at 30 turning on power supply 34. In certain implementations, coding in the RF energy itself is also used to avoid false turn-ons. When the energy converter is energized by the RF which is modulated with a proper turn-on code, and latch turns on as a result of being energized by the RF power, power is applied to the remote controlled device 14.

By using the remote energy source such as a source of RF power, the remote controlled device can be at or near zero with no standby power to await a turn-on command. The RF power source are actuated upon the user depressing a turn-on button 28 (i.e., actuating a turn-on switch—generally a momentary contact switch).

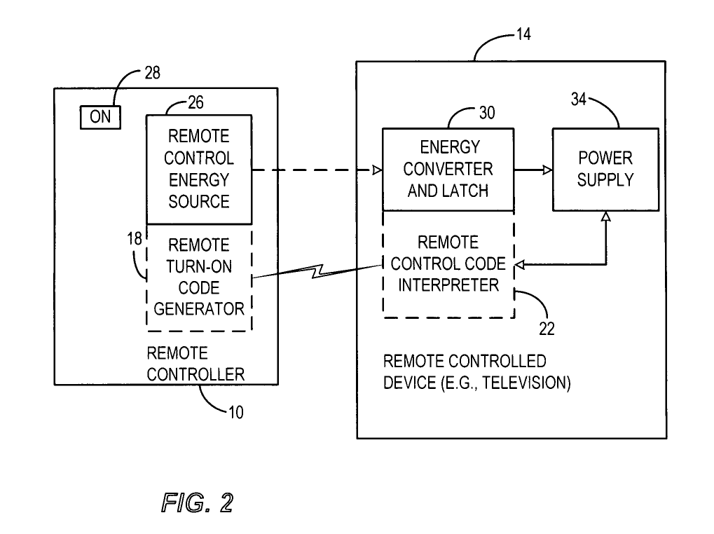

Turning now to FIG. 2, an example embodiment consistent with the invention is depicted in block diagram form. In this example, a remote controller 10 communicates with a television set or other controlled device 14. In certain implementations, multiple coding methods can be used to communicate. In this example, radio frequencies (RF) and InfraRed (IR) signaling is used in combination. This is depicted as turn on code generator 18 and remote control code interpreter or receiver 22. In accord with certain embodiments, a remote control energy source 26 comprises an RF energy source that is used to stimulate an energy conversion device (such as a resonant circuit and an RF to DC converter) that closes a latch at 30. In certain implementations, coding in the RF energy itself is also used to avoid false turn-ons. When the energy converter is energized by the RF which is modulated with a proper turn-on code, and latch turns on as a result of being energized by the RF power, power is applied to the remote control code interpreter 22 that interprets coding embedded in a separate RF or IR code sent (IR is used in this example). Once the proper set of turn-on codes is deemed to have been received, the remote control code interpreter 22 sends a control signal to the power supply 34 to turn on the remainder of the circuitry for the controlled device 14.

By using the remote energy source such as a source of RF power to derive enough power to interpret an accompanying IR code and an embedded RF code, the power of the remote controlled device can be at or near zero with no standby power being required to keep the remote control code interpreter alive to await a turn-on command. The turn-on code generator and the RF power source are actuated upon the user depressing a turn-on button 28 (i.e., actuating a turn-on switch—generally a momentary contact switch).

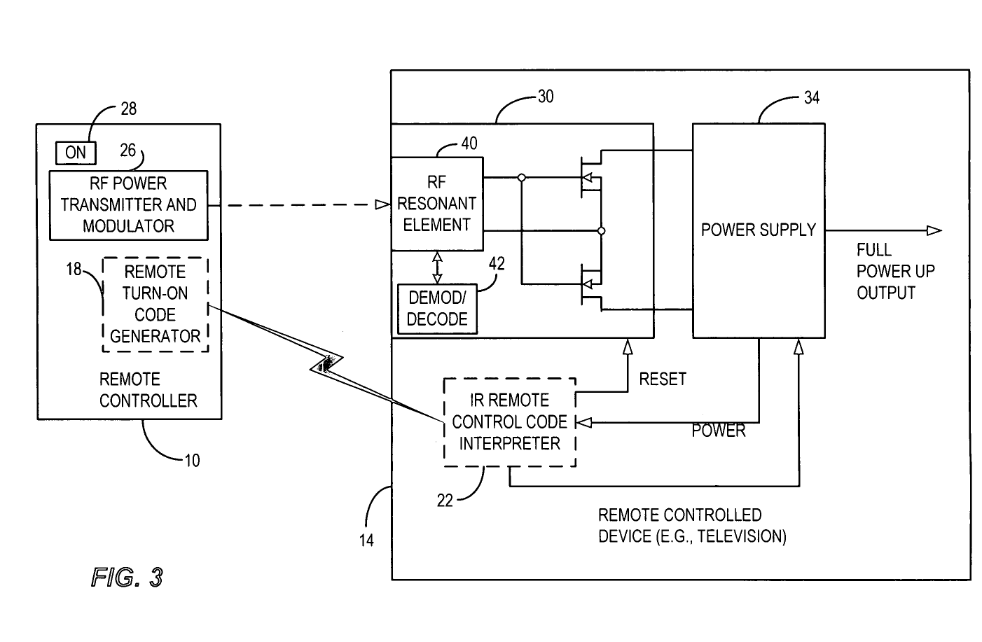

FIG. 3 depicts a more detailed implementation of the circuitry of FIG. 2 wherein the RF Power source transmitter 26 (including a modulator) is shown to stimulate one or more resonant circuits 40 which produce an electrical output upon being struck by RF energy. If an uncoded RF signal is received, it can provide power, but will not energize the IR remote control code interpreter 22. The RF power source is encoded using any suitable modulation technique (e.g., AM, FM, PM, PAM BPSK, etc.) to contain a turn-on code that is interpreted by the demodulator/decoder 42 such that the latch of 30 is only closed if the RF signal is properly encoded. This minimizes falsing of the power supply 34 to the IR remote control code interpreter 22.

When the RF transmitter 26 generates energy at the resonant circuit elements 40 which is properly encoded for turn-on, the latch circuit (shown by example as the interconnected transistor pair) creates a closed switch circuit to the power supply 34, which in turn powers up the remote control code interpreter. The IR remote control code interpreter 22 then looks to see if it is receiving a valid turn-on code from the remote controller in the form of an IR turn-on signal (or a separate RF turn-on signal. If so, a signal is sent to the power supply causing the power supply to energize the remainder of the controlled device 14. But, if no turn-on code is received within an specified time period, the latch in 30 is reset and the power supply powers down the remote control code interpreter.

In this example, the encoded RF energy stimulates a resonant circuit to produce a voltage between the MOSFET source and its gate, causing the MOSFET to turn on. A single MOSFET, or multiple MOSFETs in a paralleled array can be used to control the power supply. The resonant circuit element can be any suitable resonant element such as those used in RFID tags and other similar technologies. The output of the resonant circuit can be used to turn on back to back thyristors, silicon controlled rectifiers or transistors such as MOSFET transistors to switch the load. Other variations are also possible.

It is noted that in modern digital television sets, their complexity often dictates that they must carry out a boot-up cycle that can take several seconds. An impatient user may execute the turn-on button multiple times until he becomes accustomed to the delay in turn-on. Hence, in certain implementations, if the “on” button also serves as an “off” button, it may be desirable for the system to lock out an “on/off” command until a period of time after completion of boot up of the device or display of a signal indicative that boot up is taking place—for example, without intent of limitation, a 2-4 second delay.

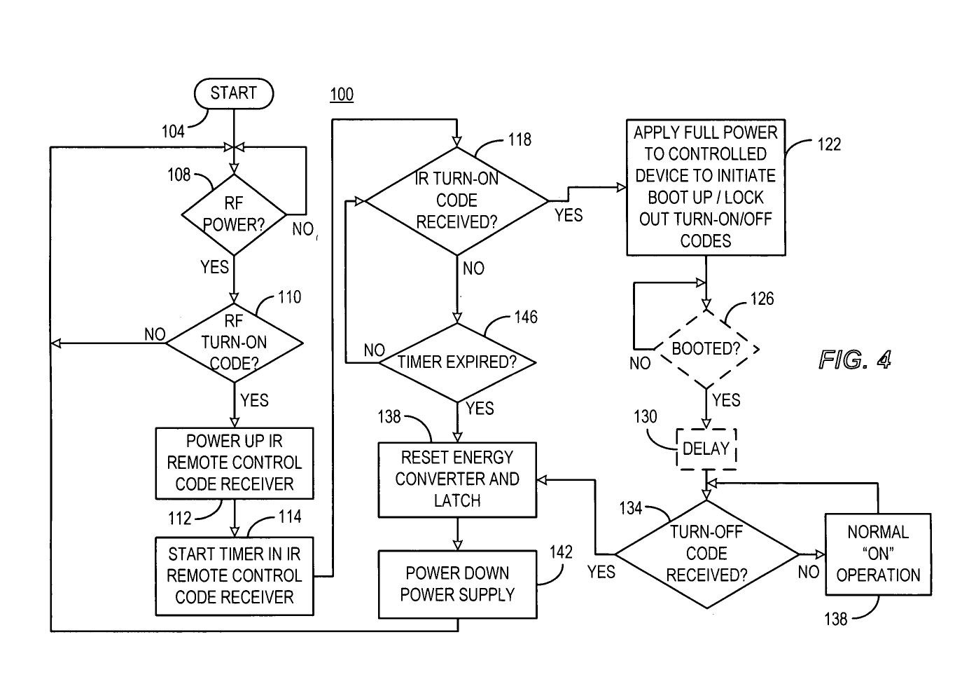

FIG. 4 depicts operation of the controlled device such as a TV set as process 100 starting at 104. When the resonant circuit elements 40 detect RF energy high enough intensity to trip the latch in 30 at 108 (in a manner similar to a solid state relay) and the RF turn-on code is detected as a part of the RF energizing signal at 110, the power supply 34 is turned on to the remote control receiver at 112 and a timer starts in the remote control code receiver/interpreter 22 at 114. The remote control code receiver then looks for a turn-on code as a separate IR (or RF) signal at 118. If one is received during the time period established by the timer at 118, the full power is applied to the controlled device at 122.

As noted earlier, it may be desirable to assure that multiple attempts at turn-on do not inadvertently result in turn-off before booting is complete. So, at 126 a check is made to determine if the TV is booted and if so, a delay is imposed at 130 of perhaps several seconds until receipt of a turn-off code is acceptable at 134. If no turn-off code is received, the controlled device operates with its normal “on” operation at 138 until a turn-off code is received at 134.

If a turn-off code is received at 134, it is not necessary for the RF transmitter 26 to energize the resonant circuit in the preferred embodiment. Once the turn-off code is received at 134, the latch in 30 is reset at 138 and the power supply is powered down at 142 and the process returns to 108 to await the next turn-on signal.

In the event a turn-on code is not received at 118 prior to expiration of the timer started at 114 at 146, control passes to 138 since the turn-on is assumed to be a false power-up of the control code receiver. This resets the latch and powers down the power supply to await the next turn-on.

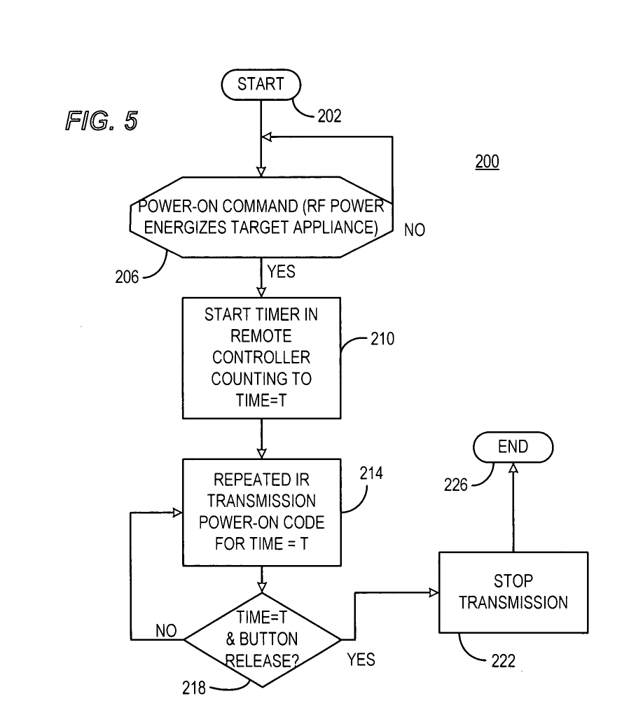

FIG. 5 depicts a process 200 in flow chart form describing the operation of the remote controller 10 in the process of turning on the remotely controlled device 14 starting at 202. The user executes a turn-on command that causes the RF transmitter to transmit RF power toward the target controlled device (e.g., TV) at 206. A timer is started either upon turning on the RF power transmitter 26 or upon release of the “on” button at 210 to establish a time period during which the remote controller will send several turn-on codes over a period of time (or count of the number of turn-on codes) at 214. When both the “on” button is released and the time T has expired (or count of turn-on codes) at 218, transmission is halted at 222 and the process ends at 226.

Many variations are possible, including two way communication to acknowledge receipt of the turn-on signal and the like without departing from embodiments consistent with the present invention.

Thus, a remotely controllable electronic appliance has a radio frequency energy converter that receives encoded radio frequency energy from a remote controller and converts the radio frequency energy to electrical energy. A demodulator and decoder decodes the encoded radio frequency energy to determine if it contains a first turn-on code. A remote control code interpreter that is receives a second turn-on code from the remote controller. The electrical energy from the energy converter is used to supply power to the remote control code interpreter when the first turn-on code is received.

In certain implementations, the electrical energy is supplied to the remote control code interpreter from a power source that is activated by the energy converter. In certain implementations, the second turn-on code is received within a specified time period of actuation of the control code interpreter. In certain implementations, upon receipt of the first and second turn-on codes, a power supply is activated to energize the electronic appliance. In certain implementations, the electronic appliance comprises a television set. In certain implementations, the remote control code interpreter is responsive to an infrared turn-on code. In certain implementations, the remote control code interpreter is responsive to a radio frequency turn-on code.

In another embodiment, a remotely controllable television has a radio frequency energy converter that receives an encoded radio frequency energy from a radio frequency transmitter in a remote controller and converts the radio frequency energy to electrical energy. A demodulator and decoder decodes the encoded radio frequency energy to determine if it contains a first turn-on code. A power source is provided. A remote control code interpreter that is receives a second turn-on code from the remote controller, where the electrical energy is supplied to the remote control code interpreter from a power source that is activated by the energy converter. The second turn-on code is received within a specified time period of actuation of the control code interpreter. The electrical energy from the energy converter is used to supply power to the remote control code interpreter when the radio frequency energy is coded with a turn-on code and where upon receipt of the second turn-on code, the power source is activated to energize the television.

In certain implementations, the remote control code interpreter is responsive to an infrared turn-on code. In certain implementations, the remote control code interpreter is responsive to a radio frequency turn-on code.

An example remote controller for an electronic appliance has a radio frequency transmitter that transmits encoded radio frequency energy from a remote controller for conversion of the radio frequency energy to electrical energy. A modulator encodes the encoded radio frequency energy with a first turn-on code. A remote control code generator generates a second turn-on code from the remote controller, where the remote controller transmits both the encoded radio frequency energy and the second turn-on code in order to effect turn-on of the electronic appliance.

In certain implementations, the second turn-on code is transmitted for a specified time period. In certain implementations, the second turn-on code is transmitted via an infrared transmitter. In certain implementations, the second turn-on code is transmitted via a second radio frequency transmitter.

An example remotely controllable electronic appliance has a radio frequency energy converter that receives a radio frequency energy from a remote controller and converts the radio frequency energy to electrical energy, where the electrical energy from the energy converter is used to supply power to receive a turn-on code.

In certain implementations, the electrical energy is supplied to the remote control code interpreter from a power source that is activated by the energy converter. In certain implementations, another turn-on code is received within a specified time period of actuation of the control code interpreter. In certain implementations, upon receipt of the turn-on codes, a power supply is activated to energize the electronic appliance. In certain implementations, the electronic appliance comprises a television set. In certain implementations, the remote control code interpreter is responsive to an infrared turn-on code. In certain implementations, the remote control code interpreter is responsive to a radio frequency turn-on code.

Certain embodiments described herein, are or may be implemented using a hardware or software processor executing programming instructions that are broadly described above in flow chart form that can be stored on any suitable tangible electronic or computer readable storage medium. However, those skilled in the art will appreciate, upon consideration of the present teaching, that the processes described above can be implemented in any number of variations without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A remotely controllable electronic appliance, comprising:
a radio frequency energy converter that receives encoded radio frequency energy from a remote controller and converts the radio frequency energy to electrical energy;
a demodulator and decoder that decodes the encoded radio frequency energy to determine if it contains a first turn-on code;
a remote control code interpreter that is receives a second turn-on code from the remote controller; and
where the electrical energy from the energy converter is used to supply power to the remote control code interpreter when the first turn-on code is received.

2. The remotely controllable electronic appliance according to claim 1, where the electrical energy is supplied to the remote control code interpreter from a power source that is activated by the energy converter.

3. The remotely controllable electronic appliance according to claim 1, where the second turn-on code is received within a specified time period of actuation of the control code interpreter.

4. The remotely controllable electronic appliance according to claim 1, where upon receipt of the first and second turn-on codes, a power supply is activated to energize the electronic appliance.

5. The remotely controllable electronic appliance according to claim 1, where the electronic appliance comprises a television set.

6. The remotely controllable electronic appliance according to claim 1, where the remote control code interpreter is responsive to an infrared turn-on code.

7. The remotely controllable electronic appliance according to claim 1, where the remote control code interpreter is responsive to a radio frequency turn-on code.

8. A remotely controllable television, comprising:
a radio frequency energy converter that receives an encoded radio frequency energy from a radio frequency transmitter in a remote controller and converts the radio frequency energy to electrical energy;
a demodulator and decoder that decodes the encoded radio frequency energy to determine if it contains a first turn-on code;
a power source;
a remote control code interpreter that is receives a second turn-on code from the remote controller, where the electrical energy is supplied to the remote control code interpreter from a power source that is activated by the energy converter;
where the second turn-on code is received within a specified time period of actuation of the control code interpreter; and
where the electrical energy from the energy converter is used to supply power to the remote control code interpreter when the radio frequency energy is coded with a turn-on code and where upon receipt of the second turn-on code, the power source is activated to energize the television.

9. The remotely controllable electronic appliance according to claim 8, where the remote control code interpreter is responsive to an infrared turn-on code.

10. The remotely controllable electronic appliance according to claim 8, where the remote control code interpreter is responsive to a radio frequency turn-on code.

11. A remote controller for an electronic appliance, comprising:
a radio frequency transmitter that transmits encoded radio frequency energy from a remote controller for conversion of the radio frequency energy to electrical energy;
a modulator that encodes the encoded radio frequency energy with a first turn-on code;
a remote control code generator that generates a second turn-on code from the remote controller; and
where the remote controller transmits both the encoded radio frequency energy and the second turn-on code in order to effect turn-on of the electronic appliance.

12. The remote controller according to claim 11, where the second turn-on code is transmitted for a specified time period.

13. The remote controller according to claim 11, where the second turn-on code is transmitted via an infrared transmitter.

14. The remote controller according to claim 11, where the second turn-on code is transmitted via a second radio frequency transmitter.

15. A remotely controllable electronic appliance, comprising:
a radio frequency energy converter that receives a radio frequency energy from a remote controller and converts the radio frequency energy to electrical energy;
where the electrical energy from the energy converter is used to supply power to receive a turn-on code.

16. The remotely controllable electronic appliance according to claim 15, where the electrical energy is supplied to the remote control code interpreter from a power source that is activated by the energy converter.

17. The remotely controllable electronic appliance according to claim 15, where another turn-on code is received within a specified time period of actuation of the control code interpreter.

18. The remotely controllable electronic appliance according to claim 17, where upon receipt of the turn-on codes, a power supply is activated to energize the electronic appliance.

19. The remotely controllable electronic appliance according to claim 15, where the electronic appliance comprises a television set.

20. The remotely controllable electronic appliance according to claim 15, where the remote control code interpreter is responsive to an infrared turn-on code.

21. The remotely controllable electronic appliance according to claim 15, where the remote control code interpreter is responsive to a radio frequency turn-on code.
